(19) United States
(12) Patent Application Publication
(10) Pub. No.: US 2006/0284131 A1
(43) Pub. Date: Dec. 21, 2006

(54) Solenoid valve

(75) Inventors: Brian M. Cripps, Bristol, CT (US); Dennis Mudge, Rocky Hill, CT (US); Kevin Wilson, Somers, CT (US)

Correspondence Address: DON W. BULSON (PARKER HANNIFIN);RENNER, OTTO, BOISSELLE & SKLAR, LLP, 1621 EUCLID AVENUE / 19TH FLOOR, CLEVELAND, OH, 44115, US

(73) Assignee: Parker-Hannifin Corporation, Cleveland, OH (US)

(21) Appl. No.: 11/419,642

(22) Filed: May 22, 2006

Related U.S. Application Data
(60) Provisional application No. 60/682,907, filed on May 20, 2005.
(60) Provisional application No. 60/777,401, filed on Feb. 28, 2006.

(51) Int. Cl. F16K 31/02

(52) U.S. Cl. 251/129.15

(57) ABSTRACT

A hub (12) for coupling a valve (10) having lead wires (14) to a conduit (16) carrying electrical lines to allow a watertight connection of the lead wires (14) to the electrical lines. The solenoid assembly (40) comprises a casing (66) including a boss (72) through which the lead wires (14) extend. The hub (12) comprises a conduit-coupling portion (84) and a boss-attaching portion (86). The boss-attaching portion (86) includes a rim (98) which is crimped to the outer surface of the boss (72) to attach the hub (12) to the solenoid assembly (40). The hub (12) is able to rotate relative to the boss (72) whereby it may be coupled to the conduit (16) without rotation of the solenoid assembly (40) and/or the conduit (16).

### RELATED APPLICATIONS

This application claims priority under 35 U.S.C. §119(e) to U.S. Provisional Patent Application No. 60/682,907 filed on May 20, 2005 and U.S. Provisional Patent Application No. 60/777,401 filed on Feb. 28, 2006. The entire disclosures of these provisional applications are hereby incorporated by reference.

### GENERAL FIELD

This disclosure relates generally to a solenoid valve and, more particularly, to a solenoid valve which is to be coupled to a conduit carrying electrical lines.

### BACKGROUND

A solenoid valve generally comprises a solenoid assembly and a plunger which moves between an opened position and a closed position in response to the solenoid assembly. For example, when the solenoid assembly is energized, the plunger can be motivated to move from a closed position to an opened position and, when the solenoid assembly is de-energized, the plunger can be mechanically biased to return to the closed position. Alternatively, the plunger can be biased to the opened position, with the energization of the solenoid moving it to the closed position. The plunger seals an orifice when in the closed position, and allows flow through this orifice when in its opened position.

A solenoid valve is often used with a valve-receiving member (e.g., a round body, a forged body, a manifold etc.) to selectively deliver fluid to a particular piece of equipment or other designation. A receiving member can include one or more supply lines, one or more interfacing cavities, and one or more delivery lines. An interfacing cavity can includes a passage communicating with the supply line(s) and a passage communicating with the delivery line(s). The orifice can be, for example, the inlet to the passage communicating with the delivery line(s), or the outlet of the passage communicating with the supply line(s). When the plunger is in the opened position, fluid will flow through the orifice to the corresponding line(s) and, when the plunger is the closed position, flow to the line(s) will be obstructed.

The solenoid assembly is energized by a current being supplied to its coil whereby, when installing the solenoid assembly, its lead wires must be connected to electrical lines. If a conduit is carrying the electrical lines, as is often required by customer specifications and/or safety standards, the conduit must be coupled to the solenoid assembly. In many situations, this conduit-coupling must be accomplished in a watertight manner.

### SUMMARY

A hub is provided for coupling a valve (and/or a solenoid assembly) to a conduit that carries electrical lines. This conduit-coupling can be accomplished in a watertight manner and without welding or other sophisticated bonding techniques. Moreover, the hub is attached to the valve (and/or the solenoid assembly) in such a manner that it can rotate relative thereto, whereby it can be turned to achieve a threaded coupling between the hub and the conduit. This ability to rotate is significant in situations, for example, where rotation of the valve, the solenoid assembly and/or the conduit is undesired, impractical, or just not possible.

The solenoid assembly can comprise a casing including a boss through which the lead lines extend. The hub can comprise a conduit-coupling portion adapted for coupling to the conduit (e.g., the conduit-coupling portion can have internal threads and the conduit can have external threads) and an attaching portion for attachment to the solenoid assembly (e.g., the attaching portion can include a rim crimped to the outer surface of the boss). The hub is able to rotate relative to the boss whereby it may be coupled to the conduit without rotation of the solenoid assembly and/or the conduit. To facilitate turning of the hub for conduit coupling or uncoupling purposes, the outer surface of the conduit-coupling portion can have a hexagonal profile with wrench-compatible platforms.

The hub-to-valve attachment can be accomplished in a water-tight manner by sealing any water-accessible seams between the hub and the casing. For example, a seal (e.g., an O-ring) can be positioned between the hub and the boss, and this seal can (or cannot) rotate during turning of the hub. Additionally or alternatively, the valve can comprise a seal (e.g., an O-ring) positioned between the casing and a fastener used to attach a flow-controlling component to the solenoid, and/or a seal (e.g., an O-ring) can be positioned between the casing and an external sealing surface surrounding the interface cavity of the receiving member.

These and other features are fully described and particularly pointed out in the claims. The following description and annexed drawings set forth in detail a certain illustrative embodiments, this embodiment being indicative of but one of the various ways in which the principles may be employed.

### DRAWINGS

FIG. 1 is perspective view, partly cut-away, of a solenoid valve connected to a receiving member and a conduit-coupling hub attached to the valve.

FIGS. 2A-2C are perspective, top, and sectional views, respectively of the solenoid assembly of the valve.

FIGS. 3A and 3B are front and sectional views respectively, of the hub.

FIG. 3C is a close-up view of a region of the hub.

FIGS. 4A and 4B are sectional views of the solenoid assembly and the hub, the hub being shown in a precrimped condition in FIG. 4A and a crimped condition in FIG. 4B.

### DETAILED DESCRIPTION

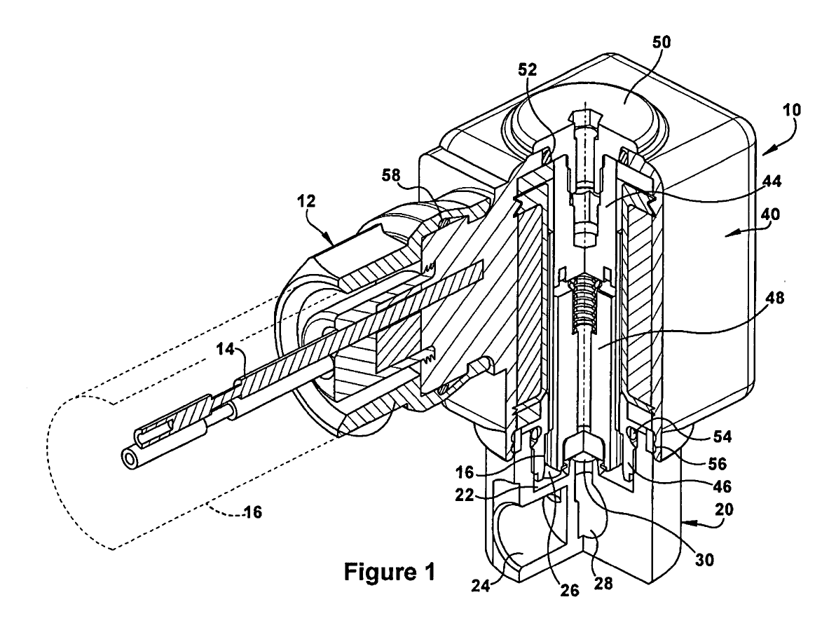

Referring now to the drawings, and initially to FIG. 1, a solenoid valve 10 and a hub 12 are shown. The hub 12 can be used during the connection of lead wires 14 to electrical lines (not shown) when installing the valve 10 at a particular location. Specifically, the hub 12 is attached to the valve 10 and can be coupled to a electrical-line-carrying conduit 16. Although the conduit coupling is typically performed in the field during the installation of the valve 10, a coupling of a length of the conduit 16 to the valve 10 at the factory is possible and contemplated.

The solenoid valve 10 is shown installed on a receiving member 20 within a valve-interface cavity 22. The receiving member 20 can be a round body (as shown), a manifold, a forged base, or any other suitable construction. The illustrated member 20 has a supply passageway 24 which provides, via an opening 26 in the bottom wall of the valve-interfacing cavity 22, a flow path into the valve 10. The receiving member 20 also has a delivery passageway 28 which provides, via an orifice 30, a flow path from the valve 10 (when the valve 10 is in an opened condition). In operation, a suitable source would supply fluid to the passageway 24 and the passageway 28 would deliver the fluid to the relevant piece of equipment as dictated by the valve 10. That being said, other arrangements of flow passageways, flow paths, orifice locations and/or openings can be additionally or alternatively used, as these are not crucial to the operation and/or construction of the hub 12.

The valve 10 generally comprises a solenoid assembly 40 having a cylindrical central chamber 42 extending axially therethrough. A stop 44 is fixedly positioned at one end of the chamber 42 and a flange 46 is fixedly positioned at the other end of the chamber 42. Although not specifically shown and/or visible in the drawings, the valve 10 can also include a tube extending between the stop 44 and the flange 46.

A plunger 48 is positioned within the chamber 42 between the stop 44 and the flange 46, and is movable between a closed position and an opened position in response to the solenoid assembly 40. In the illustrated embodiment, the plunger 48 is spring biased to the closed position, and moves to the opened position upon energization of the solenoid assembly. However, an opposite plunger arrangement (e.g., biased to the opened position and moved to the closed position by energization of the solenoid assembly 40) or any other arrangement, is possible and contemplated. In either or any event, the plunger 48 opens and closes the orifice 30 in the interfacing cavity 22 of the receiving member 20, to dictate the delivery of fluid to the passageway 28.

The stop 44 is secured to the solenoid assembly 40 via a fastener 50 and the flange 46 is threaded into the valve-interfacing cavity 22 in the receiving member 20. A seal 52 (e.g., an O-ring 52) can be positioned between the head of the fastener 50 and the solenoid assembly 40, to prevent water from seeping therebetween. A seal 54 is shown positioned between the flange 46 and the inner cylindrical wall of the valve-interfacing cavity 22, but this seal 54 may not be present in some valve designs. A seal 56 can be positioned between the solenoid assembly 40 and an external sealing surface on the receiving member 20 and a seal 58 can be positioned between the hub 12 and the relevant portion of the solenoid assembly 40 (namely a boss 72, introduced below) to prevent water from entering the conduit 14. The seals 52, 56 and 58 are situated to seal plastic-to-metal seams and other seals can be used, as necessary or desired, to seal additional or alternative plastic-to-metal or other seams, joints, or interfaces.

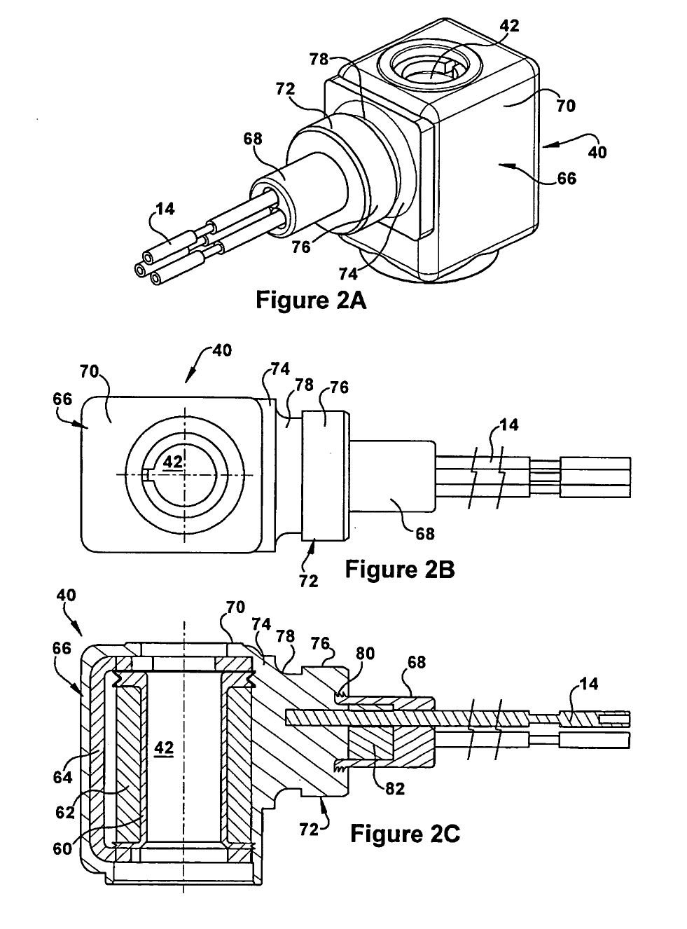

Referring now to FIGS. 2A-2C, the solenoid assembly 40 is shown in more detail. The solenoid assembly 40 generally comprises a bobbin 60 surrounding the cylindrical chamber 42, a coil 62 wrapped around the bobbin 60, a yoke 64 straddling the bobbin 60, and a casing 66 encapsulating the bobbin 60, the coil 62, and the yoke 64. The casing 66 is preferably made in one piece of a polymeric material, and can be molded or otherwise formed around the solenoid components 60, 62 and 64. The illustrated assembly 40 further comprises a housing sleeve 68 for the lead wires 14.

The casing 66 includes a block-shaped shell 70 and a boss 72 projecting from one lateral side of the block 70. The shell 70 extends the length of the solenoid chamber 42 and completely covers the outer surfaces of the bobbin 60, the coil 62, and the yoke 64. The shell's top axial side can have a sealing surface (e.g., a gland, groove, recess, etc.) surrounding the chamber 42 for the seal 52 and its bottom axial side can have a sealing surface surrounding the chamber 42 for the seal 56. The seals 52 and 56, when so positioned, seal the casing-to-yoke seams (e.g., plastic-to-metal seams) which are often not water-tight even when sophisticated techniques are used when molding the casing 66.

The boss 72 has a cylindrical shape and comprises a shell-adjacent proximate portion 74, a conduit-adjacent distal portion 76, and a ledge 78 therebetween. The housing sleeve 68 is attached to the exposed axial side of the distal portion 76. This attachment can be accomplished by the sleeve 68 including melt ribs 80 which fuse with the polymeric casing material during the encapsulation process. In the illustrated embodiment, the sleeve 68 has cavity 82 in which a potting substance (e.g., an elastomeric material) is contained to seal the interface between the boss 72 and the sleeve 68. The lead wires 14 extend from the yoke 64, through the shell 60, through the boss 62, through the potted cavity 82, and through the distal portion of the housing sleeve 68.

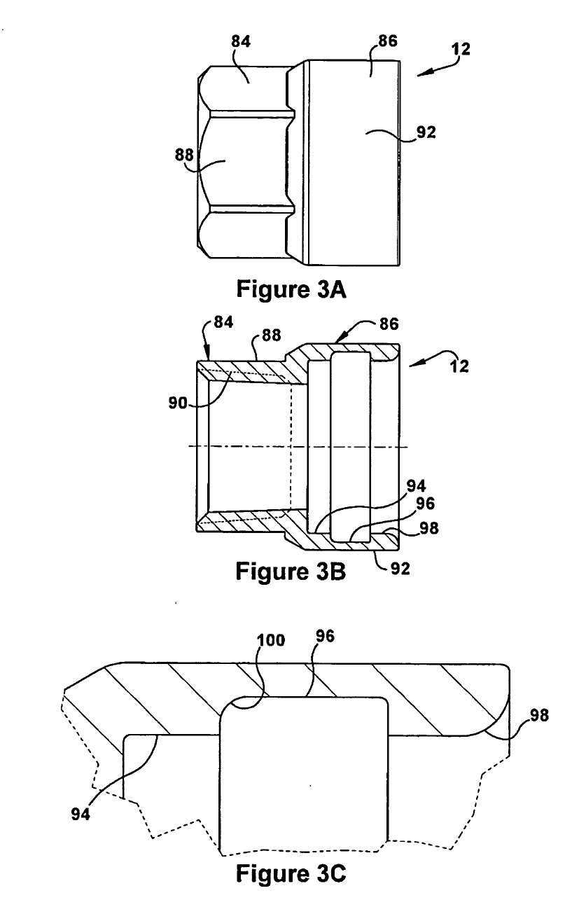

The hub 12, shown in a pre-crimped state in FIGS. 3A and 3B, comprises a conduit-coupling portion 84 and a boss-attaching portion 86. The outer surface 88 of the conduit-coupling portion 84 has a wrench-compatible hexagonal profile and its inner surface 90 is threaded for engagement with external threads on the conduit 16. The outer surface of the boss-attaching portion 86 is generally cylindrical with a slight flare where it joins the conduit-coupling portion 84. The inner surface of the boss-attaching portion 86 comprises a radially outward step 94 adjacent the conduit-coupling portion 84, a seal-receiving groove 96, and a crimpable rim 98. The proximate corner 100 of the groove 96 has a rounded shape with a curvature corresponding to the geometry of the seal 58. (See FIG. 3C.) Although in the illustrated embodiment the rim 98 is located along the remote edge of the boss-attaching portion 86, a more intermediate location is possible and contemplated, and may be desired in certain situations.

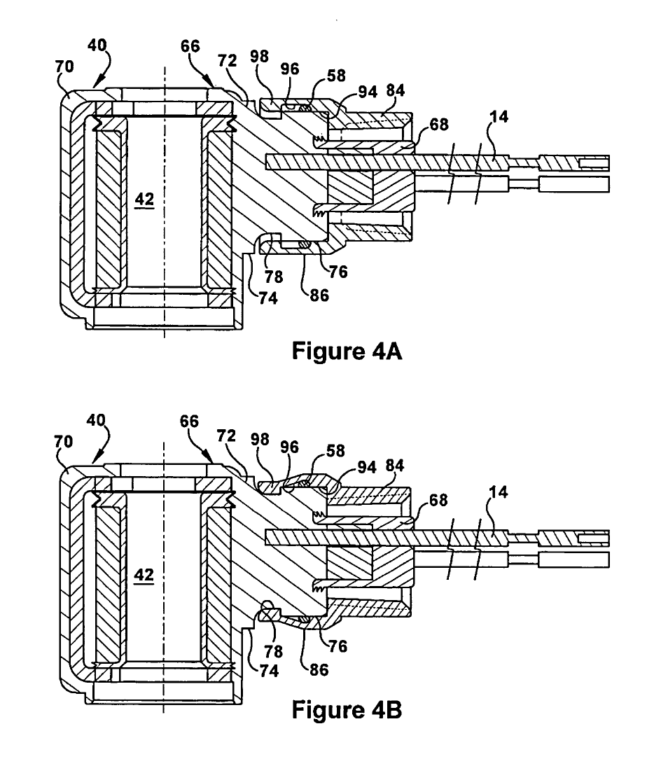

To assemble the hub 12 onto the solenoid assembly 40 (and/or the valve 10), the seal 58 is situated within the hub 12 (e.g., placed within the groove 96), and the lead wires 14 are inserted through the hub 12. The hub 12 is slid over the boss 12 until its step 94 engages the axial end of the distal portion 76 of the boss. In this predetermined position, the groove 96 will surround the distal portion 76 of the boss 72 and the rim 98 of the hub 12 will be aligned around the ledge 78 of the boss 72. (FIG. 4A.) During the placement of hub 12 around the boss 72, the seal 58 can be pushed towards the rounded edge 100 of the groove 96 and eventually lodge therewithin.

The rim 98 is then crimped into the ledge 78 of the boss 72 to thereby attach the hub 12 to the solenoid assembly 40 (and/or the valve 10). (FIG. 4B.) For the purposes of the present disclosure, “crimp” means to press, pinch, deform, mold, compress, or otherwise mechanically form a material into a desired general shape. The hub 12 can be crimped around the entire circumference of its rim 98 to form a water tight seal. To couple the hub 12 to the conduit 16, a wrench can engage and turn the hub's hex surface 88 to screw on the hub 12 onto the conduit 16. The valve 10, the conduit 16, and/or the solenoid assembly 40 need not be rotated to accomplish this coupling. The crimped rim 98 rotates about the boss 72 within the ledge 78 and the seal 58 can rotate about the boss 72 within the groove 96. The seal 58 may be lubricated (e.g., with mineral oil) prior to assembly to facilitate this rotation.

The hub 12 can be made of any crimpable (e.g., selectively deformable) material and of appropriate crimping dimensions. For example, the hub 12 can be made from a zinc alloy, such as Zamak, and may be plated to prevent corrosion in the field. The thickness of the rim 98 can be, for example, between about 0.02 inch and about 0.20 inch and the thickness of the grooved section 96 can be, for example, between about 0.01 inch and about 0.10 inch. Whatever the material and/or the thicknesses, the crimping operation should apply enough deformation so that the desired seal (e.g., a watertight joint) is formed between the hub 12 and the boss 72, while still allowing rotation of the crimped hub 12 relative thereto. The hub 12 and the solenoid assembly 42 can be selected to be able to withstand expected crimping forces so as to not be damaged during boss-attaching steps. Additionally, the hub 12 and/or the solenoid assembly 42 can be selected to withstand expected field forces such as bending, torque, and/or pulling without compromising conduit-coupling.

One may now appreciate that the hub 12 can accomplish conduit-coupling in a watertight manner, without welding or other sophisticated bonding techniques, and without requiring rotation of the valve 10, the conduit 16, and/or the solenoid assembly 40.

Although this disclosure has shown and described certain embodiments, it is obvious that equivalent alterations and modifications will occur to others skilled in the art upon the reading and understanding of this specification and the annexed drawings. In regard to the various functions performed by the elements (e.g., components, assemblies, systems, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function. In addition, while a particular feature may have been described above with respect to only one or more of several illustrated embodiments, such feature may be combined with one or more other features of the other embodiments, as may be desired and advantageous for any given or particular application. Furthermore, directional terms (e.g., upper, top, lower, bottom, above, below, left-hand, right-hand, etc.) are used only for ease in explanation when discussing the illustrated orientation and do not, unless otherwise indicated, limit the elements to any specific orientation.

1. In combination, a solenoid assembly and a hub for coupling the solenoid assembly to a conduit carrying electrical lines;
the solenoid assembly comprising a casing including a boss through which lead lines extend;
the hub comprising a conduit-coupling portion and a boss-attaching portion;
the conduit-coupling portion being adapted for coupling to the conduit;
the boss-attaching portion including a rim crimped to the outer surface of the boss to attach the hub to the solenoid assembly; and
the hub being able to rotate relative to the boss whereby it may be rotated without rotation of the solenoid assembly and/or the conduit.

2. A combination as set forth in claim 1, wherein the solenoid assembly comprises a bobbin, a coil wrapped around the bobbin, and a yoke straddling the bobbin; wherein the casing comprises a shell surrounding the bobbin, the coil, and the yoke; and wherein the boss extends outward from the shell.

3. The combination set forth in claim 1, wherein the conduit-coupling portion has internal threads for engagement with external threads on the conduit to attach the hub to the conduit.

4. The combination set forth in claim 1, wherein the boss has a ledge on its outer surface wherein the crimped rim of the hub is situated in this ledge.

5. The combination set forth in claim 1, wherein a seal is positioned between the outer surface of the boss and the inner surface of the hub.

6. The combination set forth in claim 5, wherein the inner surface of the boss-attaching portion includes a groove for the seal.

7. The combination set forth in claim 5, wherein the seal rotates with the hub when it is rotated.

8. The combination set forth in claim 1, wherein the outer surface of the conduit-coupling portion has a hexagonal profile with wrench-compatible platforms.

9. The combination set forth in claim 1, further comprising flow-controlling components for insertion into the solenoid assembly to form a valve therewith, the flow-controlling components including a plunger which moves at least between an opened position and a closed position in response to the solenoid assembly.

10. The combination set forth in claim 9, wherein the valve additionally comprises a fastener for attaching one or more of the flow-controlling components to the solenoid assembly, and a seal positioned between the fastener and the casing of the solenoid assembly.

11. The combination set forth in claim 9, further comprising a receiving member having a valve-interfacing cavity in which the valve is installed, and wherein the valve additionally comprises a seal between the receiving member and the casing.

12. The combination set forth in claim 9, further comprising a receiving member having a valve-interfacing cavity in which the valve is installed, wherein the flow-controlling components comprise a flange with external threads engaging internal threads of the valve-interfacing cavity.

13. The combination set forth in claim 9, further comprising a receiving member having a valve-interfacing cavity in which the valve is installed;
wherein the valve additionally comprises a fastener for attaching one or more of the flow-controlling components to the solenoid assembly; and
wherein the valve further comprises a seal positioned between the outer surface of the boss and the inner surface of the hub, a seal position between the fastener and the casing of the solenoid assembly, and a seal positioned between the receiving member and casing of the solenoid assembly.

14. A combination as set forth in claim 13, wherein one or more of the seals are O-rings.

15. A kit comprising a solenoid assembly and a hub for coupling the solenoid assembly to a conduit carrying electrical lines;
the solenoid assembly comprising a casing having a boss through which lead wires extend for connection to the electrical lines;
the hub having a conduit-coupling portion and a boss-attaching portion;
the conduit-coupling portion being adapted for coupling to a conduit;
the boss-attaching portion being sized to slip over at least a distal portion of the boss to a predetermined position;
the outer surface of the distal portion of the boss having a ledge and the inner surface of the boss-attaching portion of the hub having a rim;
the ledge of the boss and the rim of the hub being located so as to be aligned in the predetermined position whereby the rim can be crimped into the ledge to attach the hub to the solenoid assembly.

16. A kit as set forth in claim 15, further comprising a seal for positioning between the hub and the boss.

17. A kit as set forth in claim 15, further including flow-controlling components for insertion into the solenoid assembly to form a valve therewith, the flow-controlling components including a plunger which at least moves between an opened position and a closed position in response to the solenoid assembly.

18. A method of coupling a conduit to the solenoid assembly set forth in claim 1, said method comprising the steps of;
aligning the conduit with the hub; and
turning the hub to threadably engage external threads in the conduit with internal threads in the conduit-coupling portion of the hub.

19. A method as set forth in claim 19, wherein the turning step is performed without rotating the conduit or the solenoid assembly.

20. In combination, a solenoid assembly, a hub, and a length of conduit for carrying electrical lines;
the solenoid assembly comprising a casing including a boss through which lead lines extend;
the hub comprising a conduit-coupling portion and a boss-attaching portion;
the conduit-coupling portion being coupling to the conduit;
the boss-attaching portion including a rim crimped to the outer surface of the boss to attach the hub to the solenoid assembly.
